(19) United States
(12) Patent Application Publication
(10) Pub. No.: US 2017/0024710 A1
(43) Pub. Date: Jan. 26, 2017

(54) METHOD OF SCHEDULING PAYMENTS FOR A PRODUCT OR A SERVICE

(71) Applicant: Shelly Ann Biondi, Kansas City, MO (US)

(72) Inventor: Shelly Ann Biondi, Kansas City, MO (US)

(21) Appl. No.: 14/805,523

(22) Filed: Jul. 22, 2015

(51) Int. Cl. G06Q 20/10

(52) U.S. Cl. CPC G06Q 20/10

(57) ABSTRACT

A method of scheduling payments for a product or a service is provided. The present invention may be performed within a web based server via a software executed on a computer. The consumer first performs an action that requires payment from a merchant. For example, the consumer may select a product or service from the merchant for purchase. Once the product or service has been selected by the user, a scheduling payment link is sent. The scheduling payment link is sent to at least one of an email address and a mobile phone of the user. The user may then activate the link and enter a payment type and a scheduling input. The payment type includes a type of payment the user is using to send money for the product or service and the scheduling input includes a calendar day in which a payment is made.

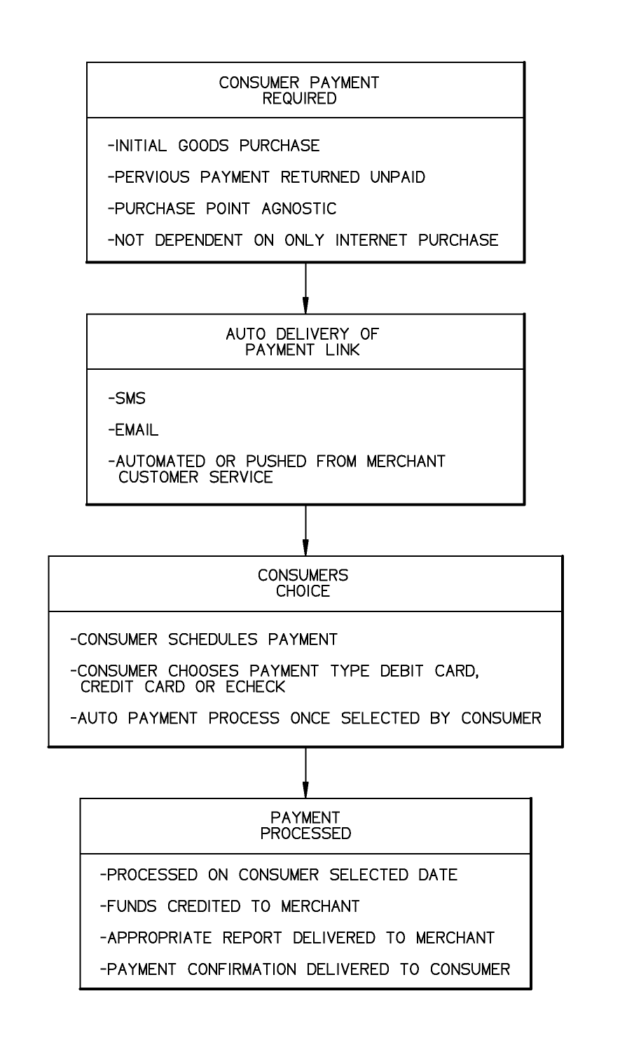

### BACKGROUND OF THE INVENTION

The present invention relates to making payments to merchants and, more particularly, to a method of scheduling payment for a product or a service.

Currently, consumers do not have control over methods of payment and payment timing for the purchase of products or services. This may be problematic if the consumer does not have the funds to purchase the product or service at that point in time.

As can be seen, there is a need for a method of scheduling payment for a product or a service.

### SUMMARY OF THE INVENTION

In one aspect of the present invention, a method of scheduling payments or refunds for a product or a service comprises: prompting a user to select a product or a service from a merchant for purchase within a web based server via a software executing a computer; receiving a selection of the product or the service by the user within a web based server via a software executing a computer; sending a scheduling payment link to at least one of an email address and a mobile phone of the user via software executing on a computer; prompting the user to activate the scheduling payment link within a web based server via a software executing on a computer; and prompting the user to enter a payment type and a scheduling input within a web based server via a software executing a computer once the user has activated the scheduling payment link, wherein the payment type comprises a type of payment the user is using to send money for the product or service, wherein the scheduling input comprises a calendar day in which a payment is made.

These and other features, aspects and advantages of the present invention will become better understood with reference to the following drawings, description and claims.

### BRIEF DESCRIPTION OF THE DRAWINGS

The FIGURE is a flowchart of an embodiment of how to use the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The present invention includes software to facilitate a consumer payment scheduling link sent to an email or as a text message in order to schedule payment due using credit card, debit card, or echeck or to reschedule the payment of a previous payment that was returned. The system of the present invention may automatically create an email or text message link for consumer delivery that allows the consumer to pick a payment date and type (echeck, credit card or debit card). The link can be sent via text message or email delivery and can be sent from the merchant or direct from a system using API functionality. The consumer then has total control over the payment type and timing.

The present invention may include a method of scheduling payments or refunds for a product or a service. The present invention may be performed via a software executed on a computer accessing a web based server. The consumer first performs an action that requires payment from a merchant. For example, the consumer may select a product or service from the merchant for purchase. Once the product or service has been selected by the user, a scheduling payment link is sent. The scheduling payment link is sent to at least one of an email address and a mobile phone of the user. The user may then activate the link and enter a payment type and a scheduling input. The payment type includes a type of payment the user is using to send money for the product or service and the scheduling input includes a calendar day in which a payment is made.

Referring to the FIGURE, performing an action that requires payment from a merchant may include at least one of the following: an initial goods and services purchase; a previous payment returned unpaid; and a purchase point agnostic. The auto delivery of the payment link may be done by text messaging (SMS) and email. The delivery may be automatically performed by a computer once the selection of the product and the service is received. The consumer or user is then prompted to activate the link. The consumer schedules the day of payment, and chooses payment type. The payment type may include, but is not limited to, a credit card, a debit card, and an electronic check. Payment is automatically processed once selected by the consumer. The payment is made on the consumer selected date and the funds are credited to the merchant. An appropriate report is delivered to the merchant and a payment confirmation is sent to the consumer.

A merchant company would use the present invention to collect money for accounts, automated return item notification and collection, and purchases made. The present invention allows consumers to schedule payment for purchases which improves the merchant reputation by being a more consumer driven and friendly organization.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method of scheduling payments or refunds for a product or a service comprising:
prompting a user to select a product or a service from a merchant for purchase within a web based server via a software executing a computer;
receiving a selection of the product or the service by the user within a web based server via a software executing a computer;
sending a scheduling payment link to at least one of an email address and a mobile phone of the user via software executing on a computer;
prompting the user to activate the scheduling payment link within a web based server via a software executing on a computer; and
prompting the user to enter a payment type and a scheduling input within a web based server via a software executing a computer once the user has activated the scheduling payment link,
wherein the payment type comprises a type of payment the user is using to send money for the product or service,
wherein the scheduling input comprises a calendar day in which a payment is made.

2. The method of claim 1, wherein the payment type comprises at least one of a credit card, a debit card, and an electronic check.

3. The method of claim 1, further comprising the step of:
sending the payment from the payment type of the user to the merchant on the calendar day selected via a software executing on a computer.

4. The method of claim 1, wherein the scheduling payment link is sent to the mobile device via text messaging.

5. The method of claim 1, wherein the step of sending a scheduling payment link is automatically performed by a computer once the selection of the product and the service is received.
